(19) United States
(12) Patent Application Publication
(10) Pub. No.: US 2006/0099051 A1
(43) Pub. Date: May 11, 2006

(54) Sealing fastener

(76) Inventor: Benjamin H. Moerke, Chippewa Falls, WI (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/155,980

(22) Filed: Jun. 17, 2005

Related U.S. Application Data
(60) Provisional application No. 60/625,293, filed on Nov. 5, 2004.

(51) Int. Cl. F16B 33/00

(52) U.S. Cl. 411/508

(57) ABSTRACT

A sealing fastener includes a sealing flange for engaging a surface of an article in which the fastener is installed. The sealing flange has a concave skirt with a seal attached to a peripheral edge of the skirt.

### CROSS-REFERENCE TO RELATED APPLICATIONS

The present regular U.S. patent application claims the benefits of U.S. Provisional Application Ser. No. 60/625,293 filed on Nov. 5, 2004.

### FIELD OF THE INVENTION

The present invention relates generally to fasteners and, more particularly, the invention pertains to push-in type fasteners having seals for creating a barrier to the penetration of moisture, dust and noise through an aperture in which the fastener is secured.

### BACKGROUND OF THE INVENTION

Push-in type fasteners are used in a variety of assemblies to secure components of the assembly. For example, in automobiles stud-like fasteners are used to secure trim parts to body panels. The fastener includes a stem with deflectable members for securing the fastener to a body panel through an aperture in the panel through which the stem is pushed. A head attached to the stem is configured for attachment to the trim part. The deflectable members are pushed through the panel and engage the panel in the hole or on a surface of the panel opposite from the surface through which the stem is inserted.

As much as reasonably possible, it is desirable to limit the generation of squeaks, rattles and objectionable noises that may be created from movement of the fastener relative to the parts to which it is connected. To minimize corrosion from within panels and the like, it is desirable also to prevent moisture from precipitation, carwashes, etc. from seeping past the fastener, and through the aperture in which the fastener is installed. A variety of sealing structures have been used to minimize rattles and squeaks and to prevent moisture seepage past the fastener. Concave skirts have been used on push-in fasteners at the base of the head, to confront the body panel around the hole through the panel. The skirt is compressed against the panel and thereby provides a biasing force against the parts of the fastener that confront the panel on the opposite side. Flexible skirts of this type also accommodate some variation in the thickness of the panel or substrate by compensating for looseness that might occur otherwise for fasteners mounted on thin panels.

Elastomeric seals have been used in conjunction with the skirt, to further improve sealing qualities against moisture penetration. The seals have been provided as a separate part slid over the stem and against the skirt or as a part adhered to or otherwise affixed to the underside of the skirt.

Although fasteners as described have been used successfully to limit squeaks and rattles and to inhibit the penetration of moisture past the fastener, further improvements are desirable. Installing the seal as a separate part is cumbersome and awkward, complicating installation of the fastener. If installed on the fastener in advance, the seal can become dislodged, even if properly placed on the fastener. In automated assembly plants, a fastener missing a seal may not be detected and may be installed on the article in which it is used inadvertently. A loose fastener of this type will rattle or squeak, may provide a path for the penetration of moisture and may not adequately secure the second article or item as required. If the seal is adhered to the skirt of the fastener, the seal may not function optimally if the fastener is not seated squarely in the panel. Further, the position of the seal relative to the fastener skirt has limited the range of panel thicknesses with which the fastener can be used effectively to provide a seal against moisture intrusion. Fasteners having substantially rigid skirts with elastomeric seals also do not provide a wide range of panel thicknesses in which the fastener can be used effectively. If the entire skirt portion is made of a flexible or elastomeric sealing material, the skirt may provide little pressure to the sealing edges of the skirt and may not provide a snug fit of the fastener relative to the article in which it is installed. As a result, it is necessary to provide a variety of different fasteners for panels of different thicknesses, and the proper fastener must be selected for installation on a panel. Further, if the seal is bonded to the skirt it may be necessary to use less than optimal materials for either the skirt or the seal or both to establish desired bonding.

What is needed is a fastener that is easy to install and includes an effective seal against moisture intrusion, with the fastener being suitable for installation on a relatively wide range of article thicknesses.

### SUMMARY OF THE INVENTION

The present invention provides a push-in type fastener having a concave skirt with an elastomeric seal extending outwardly at a peripheral edge of the skirt.

In one aspect thereof, the present invention provides a sealing fastener for engaging an article through an aperture in the article. The fastener includes a post having a distal end insertable through the aperture and engagement means associated with the post for securing the fastener relative to the article. A head attached to the post at an opposite end of the post from the distal end includes a sealing flange for confronting and engaging the first side of the article surrounding the aperture. The sealing flange includes a skirt with a peripheral edge and a seal engaging the peripheral edge and surrounding the skirt.

In another aspect thereof, the present invention provides a sealing flange for a push-in fastener having a post. The sealing flange is a concave skirt extending outwardly from the post and has a peripheral edge. A seal engages and surrounds the peripheral edge of the skirt, and extends outwardly thereof

In a still further aspect thereof, the present invention provides a sealing flange for a push-in fastener having a post. The sealing flange includes a concave skirt extending outwardly from the post. The skirt has inner and outer surfaces and a peripheral edge; and a seal surrounding the peripheral edge. The seal has an inner portion overlying a portion of the inner surface adjacent the peripheral edge, an outer portion overlying a portion of the outer surface adjacent the peripheral edge, and an edge portion interconnecting the inner and outer portions outwardly of peripheral edge.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a sealing fastener in accordance with the present invention; and

FIG. 2 is a cross-sectional view of the fastener shown in FIG. 1, with the fastener illustrated installed in a panel.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

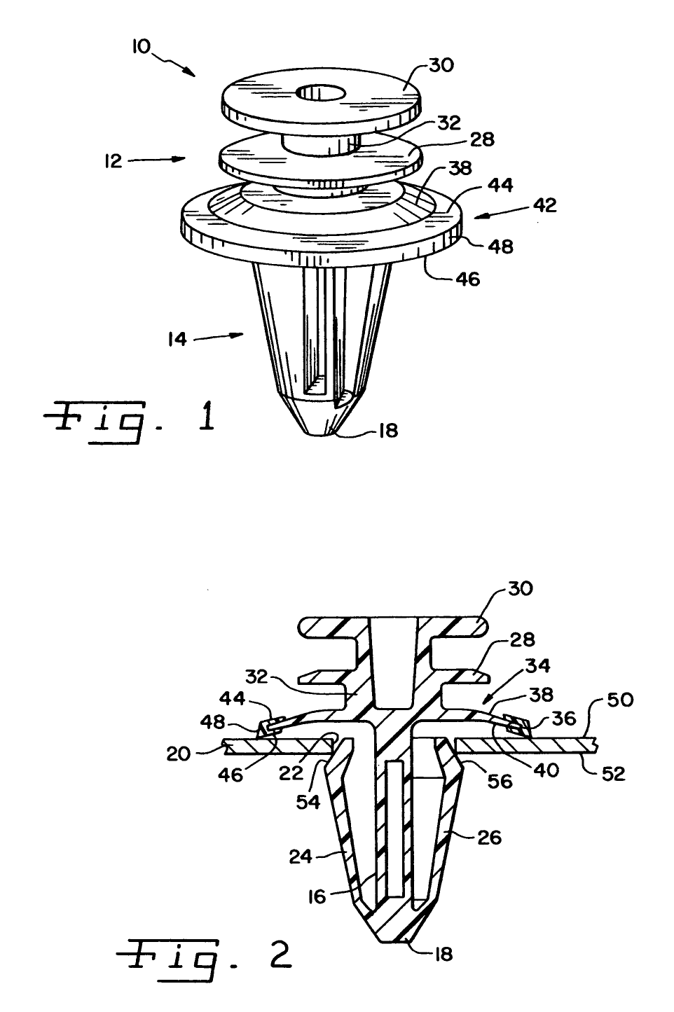

Referring now more specifically to the drawings and to FIG. 1 in particular, numeral 10 designates a fastener in accordance with the present invention. The fastener 10 includes a head 12 and a snap engaging stem 14. Head 12 and stem 14 can be formed as a monolithic body by injection molding or other suitable molding or fabrication process. The material for fastener 10 can be selected as optimally desirable for its particular installation and use. Accordingly, fastener 10 can be formed of plastic, such as nylon. It should be understood that the exemplary embodiment for fastener 10 and the particular configurations for snap engaging stem 14 and head 12 are provided as suitable for the particular installation.

Snap engaging stem 14 includes a post 16 having a distal end 18. Post 16 is connected to head 12 at an end of post 16 opposite distal end 18. An engagement means is associated with snap engaging stem 14 for securing fastener 10 relative to an object such as a panel 20 (FIG. 2) having an aperture 22 therein. In the exemplary embodiment, deflectable prongs 24 and 26 are provided for securing fastener 10 relative to panel 20. Deflectable prongs 24 and 26 are joined or connected to post 16 near distal end 18 and project from distal end 18 toward head 12. Deflectable prongs 24 and 26 angle outward slightly to define a wider area near the unattached ends thereof than near distal end 18 of post 16. Deflectable prongs 24 and 26 are spaced from post 16 throughout the substantial entire lengths of deflectable prongs 24 and 26. It should be understood that the specific configuration of the engaging means can vary relative to the specific application requirements.

Head 12 is configured for attachment to a second article or item (not shown) which is to be positioned and secured relative to panel 20. Accordingly, in the exemplary embodiment shown, head 12 includes configurations 28 and 30 in the way of substantially circular plates projecting from a core 32. Head 12 can be connected to another item having a keyhole opening therein for engaging configurations 28 and 30. It should be understood that the specific configuration of head 12 can vary relative to the article to be attached and structures on the article by which it can be connected to fastener 10. Core 32 is an extension of post 16 but can be configured the same as or differently than post 16. Together post 16 and core 32 provide rigidity and strength to fastener 10 from head 12 to distal end 18.

Head 12 further includes a skirt 34 extending outwardly from core 32 adjacent panel 20 when fastener 10 is installed. Skirt 34 is concave toward distal end 18 and is resiliently bendable for confronting and engaging panel 20. Thus, skirt 34 can be tapered so as to be thinner near peripheral edge 36 than near core 32, as viewed in cross-section between an outer surface 38 and an inner surface 40 of skirt 34. Skirt 34 is shaped to surround aperture 22, and in the exemplary embodiment skirt 34 is substantially round or circular. However, depending on the size and shape of aperture 22, it should be understood that skirt 34 can be of other shapes as well.

A seal 42 is associated with skirt 34 at peripheral edge 36. Seal 42 is substantially U-shaped in cross-section as shown in FIG. 2. Accordingly, seal 42 includes an outer portion 44 overlying a portion of outer surface 38 adjacent edge 36 and an inner portion 46 overlying a portion of inner surface 40 adjacent peripheral edge 36. An edge portion 48 of seal 42 interconnects outer portion 44 and inner portion 46. Thus, seal 42 is a contiguous body encapsulating or engaging a radially outer portion of skirt 34, and extends radially outwardly of peripheral edge 36.

Seal 42 can be formed as a separate body in a separate process apart from fastener 10 and thereafter stretched as necessary and fitted over skirt 34. Alternatively, seal 42 can be formed in place on skirt 34 in an overmolding or two-shot process in which fastener 10 is formed in a first molding step and seal 42 is formed on skirt 34 in a second step. Depending on the materials used, there can be some adhesion between seal 42 and skirt 34 from the molding process. However, because of the configuration of seal 42, with seal 42 surrounding or encapsulating a portion of the outer edge of skirt 34, seal 42 is mechanically held in place on skirt 34 and no adhesive is required. Even without a bond, because of the tight fit, seal 42 will remain in proper position during normal transportation, handling and use.

Seal 42 can be made of material advantageous for the sealing properties required in the particular application and use of fastener 10. Thus, seal 42 can be made of a synthetic elastomer. An acetal or nylon material is an appropriate material for many uses and applications of fastener 10.

Flexibility and springiness can be provided by thinning a peripheral portion of skirt 34, with strength retained from a thicker portion of skirt 34 adjacent core 32. Accordingly, a tight fit of fastener 10 relative to aperture 22 in panel 20 is available. With seal 42 extending outwardly from peripheral edge 36 of skirt 34, together with the concave shape of skirt 34 and the positioning of deflectable prongs 24 and 26 relative to skirt 34, fastener 10 can be configured to accommodate a variety of thicknesses for panel 20. Fastener 10 will be securely installed in panels of different thicknesses yet will provide a secure moisture barrier by seal 42 throughout the range of panel thicknesses for which fastener 10 is configured.

Outer portion 44 of seal 42 is shown as a continuous, uninterrupted body, and can be used as such. However, to facilitate stretching for installation of a separately formed and discrete seal 42, outer portion 44 can be provided with voids therein or as a series of spaced segments or fingers connected to edge portion 48.

Fastener 10 is used by inserting distal end 18 into aperture 22 through a first side 50 of panel 20 and past a second side 52 of panel 20. Deflectable prongs 24 and 26 are deflected inwardly as fastener 10 is inserted, but rebound outwardly as prongs 24 and 26 near full completion of insertion. Angular ends 54 and 56 are provided on prongs 24 and 26, respectively, to provide a more gradual and controlled rebound of prongs 24 and 26 as installation of fastener 10 is completed.

Seal 42 engages panel 20, and as fastener 10 is further inserted, skirt 34 is caused to flatten to accommodate the thickness of the panel. Thus, skirt 34 provides a biasing force urging prongs 24 and 26 against second side 52 of panel 20, to ensure secure mounting of fastener 10 relative to panel 20. Additionally, the flattening and biasing force provided by skirt 34 holds seal 42 snuggly against panel 20, providing an effective barrier against moisture intrusion to aperture 22.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

What is claimed is:

1. A sealing fastener for engaging an article through an aperture in the article, said fastener comprising:
a post having a distal end insertable through the aperture;
engagement means associated with said post for securing said fastener relative to the article;
a head attached to said post at an opposite end of said post from said distal end;
said head including a sealing flange for confronting and engaging the first side of the article surrounding the aperture, said sealing flange including a skirt with a peripheral edge and a seal engaging said peripheral edge and surrounding said skirt.

2. The fastener of claim 1, said skirt being concave toward said distal end.

3. The fastener of claim 2, said skirt having a substantially circular peripheral edge.

4. The fastener of claim 3, said seal having contiguous portions that engage said peripheral edge of said skirt and portions of inner and outer surfaces of said skirt.

5. The fastener of claim 4, said seal being an elastomer.

6. The fastener of claim 5, said engagement means including a plurality of prongs connected to said distal end and extending toward said head outwardly of and in spaced relation to said post.

7. The fastener of claim 1, said seal having contiguous portions that engage said peripheral edge of said skirt and portions of inner and outer surfaces of said skirt.

8. The fastener of claim 7, said seal being an elastomer.

9. The fastener of claim 1, said engagement means including a plurality of prongs connected to said distal end and extending toward said head outwardly of and in spaced relation to said post.

10. The fastener of claim 1, said skirt being thinner near said peripheral edge than near said post.

11. A sealing flange for a push-in fastener having a post; said sealing flange comprising:
a concave skirt extending outwardly from said post and having a peripheral edge; and
a seal engaging said peripheral edge of said skirt, said seal surrounding said peripheral edge and extending outwardly thereof.

12. The sealing flange of claim 11, said skirt having a substantially circular peripheral edge.

13. The sealing flange of claim 12, said seal having contiguous portions that engage said outer edge of said skirt and overlie portions of inner and outer surfaces of said skirt.

14. The sealing flange of claim 13, said seal being an elastomer.

15. The sealing flange of claim 11, said seal having contiguous portions that engage said outer edge of said skirt and overlie portions of inner and outer surfaces of said skirt.

16. The sealing flange of claim 15, said seal being an elastomer.

17. The sealing flange of claim 11, said seal being an elastomer.

18. A sealing flange for a push-in fastener having a post; said sealing flange comprising:
a concave skirt extending outwardly from said post, said skirt having inner and outer surfaces and a peripheral edge; and
a seal surrounding said peripheral edge, said seal having an inner portion overlying a portion of said inner surface adjacent said peripheral edge and an outer portion overlying a portion of said outer surface adjacent said peripheral edge, and said seal having an edge portion interconnecting said inner and outer portions outwardly of peripheral edge.

19. The sealing flange of claim 18, said seal being an elastomer.

20. The sealing flange of claim 18, said outer portion being a continuous, uninterrupted body.
